(19) United States
(12) Patent Application Publication
(10) Pub. No.: US 2023/0045801 A1
(43) Pub. Date: Feb. 16, 2023

(54) BODY OR CAR MOUNTED CAMERA SYSTEM

(71) Applicant: Edge AI, LLC, Jacksonville, FL (US)

(72) Inventor: Michael C. Pinkus, Cumming, GA (US)

(21) Appl. No.: 17/886,227

(22) Filed: Aug. 11, 2022

Related U.S. Application Data
(60) Provisional application No. 63/232,037, filed on Aug. 11, 2021.

(51) Int. Cl. H04N 7/18; H04N 5/232; G06V 20/52

(52) U.S. Cl. CPC H04N 7/181; G06V 20/52; H04N 5/23203; H04N 5/23222

(57) ABSTRACT

A camera system includes an administrator and a series of camera nodes which includes an audio microphone for also including sound in the video data file. The administrator includes a computer server, a wireless transmitter/receiver (transceiver), and machine learning (ML) chips. Each camera node includes a video capturing device or camera, a wireless transmitter/receiver (transceiver), a plurality of ML chips, and a GPS sensor. The ML chips are capable of receiving data in the form of a video file and processing the data to determine if the data includes “actionable” data. The ML chip makes certain inferences from the captured video data. The camera nodes are wirelessly linkable to each other. The communication between the several camera nodes form a “mesh network” wherein the several camera nodes may transmit data to each other, thus propagating the camera nodes with the mesh network with common data, rules, or inferences.

### CROSS REFERENCE TO RELATED APPLICATIONS

This application claims the benefit of U.S. Provisional Pat. Application No. 63/232,037 filed Aug. 11, 2021 and entitled “Body Or Car Mounted Camera System”, and is incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The present inventive concept relates to the field of body cameras or vehicle cameras. More particularly, the invention relates to a meshed system of body or vehicle camera that have select learning capabilities.

### Technology in the Field of the Invention

Body worn cameras or vehicle mounted cameras are oftentimes used by police officers to capture video and other data during patrols and incidents. Such body worn cameras may also be referred to as wearable cameras. Captured data may subsequently be needed as evidence when investigating crimes and prosecuting suspected criminals. In order to preserve such evidence, a data management system, such as a video management system or an evidence management system may be used. Such data management systems generally provide storage of captured data, and also viewing of the captured data, either in real time or as a playback of recorded data. Depending on the sophistication of the data management system, it may provide possibilities of linking data of many types to a case. For instance, video data of the same incident may have been captured by several cameras, body worn cameras as well as fixedly mounted surveillance cameras. Further, audio data may have been captured by some or all of those cameras, as well as by other audio devices. The video and audio data may be tagged, automatically and/or manually with meta data, e.g., geographical coordinates indicating where the data were captured.

There are different ways of transferring captured data from a body worn camera to the data management system. Some systems download the data at the end of a select time period, such as the end of a policeman’s shift when the device is placed on a docking station when the policeman returns to the station. Some systems rely on a continuous wireless transfer of data from the camera to the data management system located on a server in the police station.

However, a problem with vehicle/body worn cameras is that the recorded video and audio qualities and/or duration may be poor due to the capture rate as a result of the limitations on data storage for the device. Also, these types of devices are generally static in that they do not provide any information to the wearer, but merely record the scene or incident.

Accordingly, a need exists for a body or vehicle camera that provides information to the wearer while also providing higher quality and/or duration of video and/or audio recordings of a particular incident. It is to the provision of such therefore that the present invention is primarily directed.

### SUMMARY OF THE INVENTION

A camera system comprises a plurality of camera nodes wherein each the camera node has a video camera, a machine learning chip electronically coupled to the camera, electronic data storage coupled to the machine learning chip, and a wireless transceiver electronically coupled to the machine learning chip. Each wireless transceiver is capable of wireless communication with each the wireless transceiver of the plurality of camera nodes. The camera system also has a remote administrator server having a wireless transceiver capable of wireless communication with at least one the wireless transceivers of the plurality of camera nodes. With this construction, data may be transmitted from the wireless transceiver of the remote administrator server to at least one wireless transceiver of the plurality of camera nodes, and subsequently the data may be transmitted from that at least one wireless transceiver of the plurality of camera nodes to other wireless transceivers of other wireless transceivers of the plurality of camera nodes.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a schematic view of a camera system embodying principles of the invention in a preferred form.

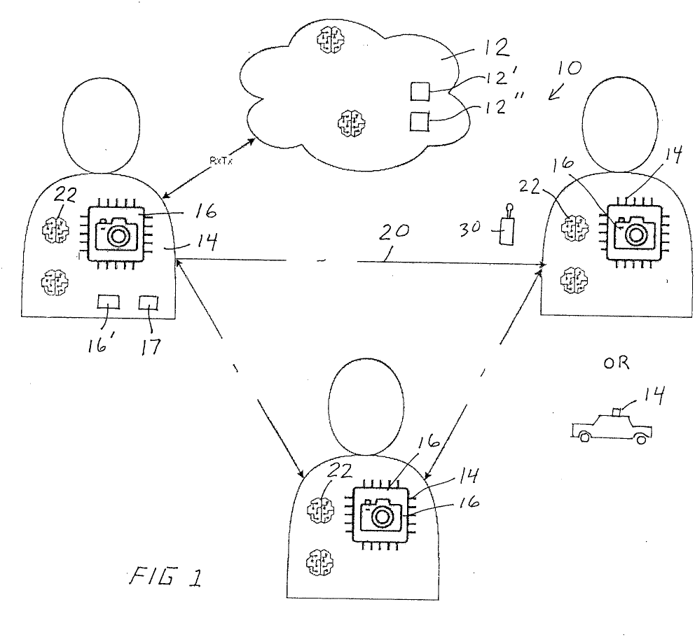

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

With reference next to the drawings, there is a shown a sensor such as a trail camera, body camera, vehicle camera, security camera, audio recorder, referenced hereinafter simply as a camera system 10, in a preferred form of the present invention. The camera system 10 includes an administrator or cloud computing center 12 and a series or plurality of mobile video cameras or camera nodes 14, which typically includes an audio microphone for also including sound in the video data file. The camera nodes 14 may be in the form of body worn video cameras or vehicle mounted video cameras, or a combination of such.

The cloud computing center 12 includes a computer server 12', a wireless transmitter/receiver (transceiver) 12", and machine learning (ML) chips. The term machine learning (ML) chips, also known as an artificial intelligence (AI) accelerator, means a specialized integrated circuit accelerator or hardware system designed to accelerate artificial intelligence and/or machine learning, which enables/enhances deep learning machine functions.

Each camera node 14 includes a video capturing device or camera 16, a wireless transmitter/receiver (transceiver) 16, a plurality of ML chips 22, and a GPS sensor 17. The camera 16 is capable of taking and storing video files and correlating audio files, or a combination of such. The camera node 14 may also include other sensors to aid in processing data, such as a temperature sensor, device orientation sensor, camera orientation sensor, and/or accelerometer.

The ML chips 22 are capable of receiving data in the form of audio/video/sensor files and processing the data to determine if the data includes “actionable” data. As used herein, the term actionable data is intended to mean data that reflects an event that relates to an action that should be saved and provided to the cloud computing center 12 or other cameras 16, such as a confrontation with a criminal suspect. As such, the ML chip 22 makes certain inferences from the captured audio/video/sensor data.

The camera nodes 14 are wirelessly linkable to each other by a wireless mesh network 20 through the transmitter/receiver (transceiver) 16. The mesh network provides a real time communication of commands and logging actions, such as, "turn on camera", turn off camera", turn on audio", or "turn off audio". This allows any camera node 14 to turn on other video cameras 14 via a voice or tactile device command. Thus, the inferences or “rules” followed by the ML chip 22 are downloaded to the ML chip 22 from the cloud computing center 12, and the inferences or rules may be propagated or transmitted from one camera node 14 to another camera node 14 so that all camera nodes 14 may be operating on a common set of inferences, for example, for a certain select event occurring in real time. The camera nodes 14 may also transmit data back to the cloud computing center 12.

The transceiver 16 may also communicate (data download) with an ancillary data device 30 such as a proximal cellular telephone, tablet or computer. Thus, if connectivity to a public data system (internet) is lost with the camera node 14, the camera node 14 may be connected with the ancillary device 30, that may be operating on another or different system.

The communication between the several camera nodes 14 form a “mesh network” wherein the several camera nodes 14 may transmit data to each other, thus propagating the camera nodes 14 with the mesh network with common data, rules, inferences, etc.

In use, the camera system may provide stereo audio location determinations, wherein the system recognizes an event, such as the sound of a gunshot, through a timing sequence between the detection of the event at the different geographic locations of the camera nodes 14. This is done through the confirmation of the sound and determining the vector and distance of the sound from each camera node 14, which may be conducted through the cloud computing center 12 or the camera nodes 14. The resulting inferred geographic location is then transmitted to each of the camera nodes 14 so that the person wearing the camera may be provided with the geographic location of the event. The recorded event and resulting inferred geographic location is also transmitted to the cloud computing center 12. The recorded data may also include meta data relating to the event, such as the time, location, temperature, humidity, altitude, camera orientation, and/or device orientation.

The camera nodes 14 may also receive data, inferences, or rules from the cloud computing center 12 for action by the wearer. For instance, the cloud computing center 12 may download target data such as a photograph of a face of a person to be located. The ML chip of the camera node 14 runs real-time facial recognition software to find a match between the face in the photograph and the faces of people captured by the camera 16 of the camera node 14. This same photograph and possibly inferences for the photograph may then be sent from one camera node 14 to another camera node 14 so that all camera nodes 14 within the geographic area may be searching for the same person depicted in the photograph, i.e., a common set of rules or inferences are being processed by all camera nodes within the mesh network. An example of this process may occur in the event of a mall shooting, wherein a photograph of the suspect and rules or inferences (facial recognition) may be downloaded to a first camera node 14 which then propagates the photograph and the inference/rules (facial recognition) to the other camera nodes in the area so that all camera nodes are now focused on the same critical event using the same data. The processing of the data occurs locally at each camera node 14 rather than globally through an internet connection or the like.

Upon the recognition of a person, a match occurring between the photograph and a person in the area of the camera node 14, the camera node 14 produces a notification signal to the wearer. The notification signal may be a sound, light, tactic (vibration), or any other similar means. The camera node 14 may also alert or provide a status update to other camera nodes 14 in the mesh network as well as the cloud computing center 12. As such, the mesh network enables camera nodes 14 that may not be capable of reaching the internet or other public communication system to receive data through the other camera nodes in the mesh network. This type of peer to peer networking may be considered “eventual consistency”.

Similarly, the ML chip may include software or learning capabilities so that the camera node 14 may determine the emotional status of an individual captured by the camera 16 of a camera node 14. Thus, the camera node 16 may aid in locating an individual within a crowd of people based on the individual’s scared or angry expression.

The just described camera system 10 utilize ML chips 22 which with today’s technology may have limitations as to the number of programs or rule sets that can be processed at any given time. However, the program or rule sets may be changed at any given time through a downloading of the program from the cloud computing center 12 to the camera node 14. Thus, the ML chips 22 may contain five different rule setting, but the user may select to process only one critical rule setting for that particular time, such as facial recognition when searching the crowd for a suspect. Also, a new rule set may be downloaded by removing a prior existing rule set from the ML chip and replacing it with the new rule set.

Similarly, the ancillary device 30 may be utilized to store a number of rule sets that can be selectively downloaded to the camera node 14 at a desired time. For example, the ancillary device 30 may contain 100 different rule sets, however, the rule sets being held within the camera node 14 may be limited to 10 different rule sets. Therefore, the ancillary device may be used to locally exchange operating rule sets upon command at a given time.

The microphone of the camera node 14 may be utilized to inform or update other camera nodes on the mesh network with the use of voice commands. Thus, an office may say “I am 10-6”, meaning the officer is busy, the camera node processing recognizes this voice command to propagates it to the other camera nodes 14 so that all officers in the proximal area are aware that the officer is occupied.

The system also aids in providing fault tolerance, as each device is backing up the other devices in the mesh network. Thus, the entire system has multiple locations of the data being recorded or processed in case of the accidental loss of one of the stored locations of the data, providing an additional integrity to the entire system.

Each camera node 14 is encrypting and signing each transmission for security purposes, as this avoids spoofing and other false entries of data.

Another feature of the present system is the ability to enhance the quality and/or duration of the video data. The camera node 14 has a learning model saved in the ML chips 22 that continuously monitor the video data being acquired through the camera 16. The ML chips 22 may discard or minimize any video data that it deems to be unworthy or uneventful, thus reducing the amount of data being saved by the camera node 14. The ML chip may also recognize the occurrence of a worthy event and as a result of such recognition increase the recording speed or resolution of the camera 16 to increase the quality of the recorded video data. Thus, the video data relating to important events are better in quality, while the unimportant events are either deleted or reduced in data size.

Yet another feature of the present system is the ability to locate and notify the user of select criteria that may not be related to the recognition of humans. For example, the cloud computing center 12 may download a license plate number to the camera nodes 14. The data produced by the camera 16 of the camera nodes 14 may be constantly analyzed so that if the license plate appears in the view of the camera 16 and camera node 14 instantly notifies the wearer and or the cloud computing center 12. The camera node 14 may also record and provide other meta data relating to the timing of the location, such as its GPS location, time, car make, and faces of people in the immediate vicinity of the car.

A camera system comprises a plurality of camera nodes wherein each the camera node has a video camera, a machine learning chip electronically coupled to the camera, electronic data storage coupled to the machine learning chip, and a wireless transceiver electronically coupled to the machine learning chip. Each wireless transceiver is capable of wireless communication with each the wireless transceiver of the plurality of camera nodes. The camera system also has a remote administrator server having a wireless transceiver capable of wireless communication with at least one the wireless transceivers of the plurality of camera nodes. With this construction, data may be transmitted from the wireless transceiver of the remote administrator server to at least one wireless transceiver of the plurality of camera nodes, and subsequently the data may be transmitted from that at least one wireless transceiver of the plurality of camera nodes to other wireless transceivers of other wireless transceivers of the plurality of camera nodes.

A camera system comprises a plurality of camera nodes wherein each camera node has a video camera, a machine learning chip electronically coupled to the camera, electronic data storage coupled to the machine learning chip, and a wireless transceiver electronically coupled to the machine learning chip. Each wireless transceiver is wirelessly communicable with the wireless transceivers of the other camera nodes of the plurality of camera nodes. The camera system also has a remote administrator server having a wireless transceiver wirelessly communicable with at least one wireless transceivers of the plurality of camera nodes. The camera system also has system software operating the plurality of camera nodes and the remote administer server. The system software propagates operational instructions from the remote administrator server to at least one camera node of the plurality of camera nodes wherein the operational instructions are then further propagated between the one camera node and other camera nodes.

It will be appreciated that the inventions are susceptible to modification, variation and change without departing from the spirit and scope of the invention as set forth in the claims

1. A camera system comprising:
a plurality of camera nodes, each said camera node having a video camera, a machine learning chip electronically coupled to said camera, electronic data storage coupled to said machine learning chip, and a wireless transceiver electronically coupled to said machine learning chip, each said wireless transceiver capable of wireless communication with each said wireless transceiver of said plurality of camera nodes, and
a remote administrator server having a wireless transceiver capable of wireless communication with at least one said wireless transceivers of said plurality of camera nodes,
whereby data may be transmitted from the wireless transceiver of the remote administrator server to at least one wireless transceiver of the plurality of camera nodes, and subsequently the data may be transmitted from that at least one wireless transceiver of the plurality of camera nodes to other wireless transceivers of other wireless transceivers of the plurality of camera nodes.

2. The camera system of claim 1 wherein said wireless transceiver of said remote administrator server is capable of wireless communication with each said wireless transceiver of said plurality of camera nodes.

3. The camera system of claim 1 wherein said machine learning chip of each camera node of said plurality of camera nodes is capable of distinguishing actionable data from non-actionable data, and wherein said machine learning chip stores the data from the camera if the machine learning chip determines that the data is actionable data.

4. The camera system of claim 3 wherein said machine learning chip of each camera node of said plurality of camera nodes stores the actionable data within said electronic data storage coupled to said machine learning chip and does not store the non-actional data.

5. The camera system of claim 3 wherein said machine learning chip of each camera node of said plurality of camera nodes stores the actionable data within said electronic data storage coupled to said machine learning chip and stores the non-actional data within said electronic data storage coupled to said machine learning chip, said stored actionable data being stored at a higher resolution than the resolution of the stored non-actionable data.

6. The camera system of claim 1 wherein each said machine learning chip and electronic data storage maintains a first select number of inference rules, and wherein said remote administrator server maintains a second select number of inference rules, wherein said first select number of inference rules is less than said second select number of inference rules.

7. The camera system of claim 1 wherein said remote administrator server includes a machine learning chip.

8. The camera system of claim 1 wherein said remote administrator server includes a global position sensor.

9. The camera system of claim 1 further comprising an ancillary data device in wireless communication with at least one said transceiver of said plurality of camera nodes.

10. The camera system of claim 1 wherein said plurality of camera nodes is a plurality of body mount camera nodes.

11. A camera system comprising:
a plurality of camera nodes, each said camera node having a video camera, a machine learning chip electronically coupled to said camera, electronic data storage coupled to said machine learning chip, and a wireless transceiver electronically coupled to said machine learning chip, each said wireless transceiver being wirelessly communicable with said wireless transceivers of the other camera nodes of said plurality of camera nodes;
a remote administrator server having a wireless transceiver wirelessly communicable with at least one said wireless transceivers of said plurality of camera nodes, and
system software operating said plurality of camera nodes and said remote administer server, said system software propagating operational instructions from said remote administrator server to at least one said camera node of said plurality of camera nodes wherein the operational instructions are then further propagated between said one camera node and other camera nodes.

12. The camera system of claim 11 wherein said system software is programmed to recognize select events, and wherein said system software initiates the propagation of select operational instructions in response to the sensing of the select event.

13. The camera system of claim 11 wherein said wireless transceiver of said remote administrator server is capable of wireless communication with each said wireless transceiver of said plurality of camera nodes.

14. The camera system of claim 11 wherein said machine learning chip of each camera node of said plurality of camera nodes is capable of distinguishing actionable data from non-actionable data, and wherein said machine learning chip stores the data from the camera if the machine learning chip determines that the data is actionable data.

15. The camera system of claim 14 wherein said machine learning chip of each camera node of said plurality of camera nodes stores the actionable data within said electronic data storage coupled to said machine learning chip and does not store the non-actional data.

16. The camera system of claim 14 wherein said machine learning chip of each camera node of said plurality of camera nodes stores the actionable data within said electronic data storage coupled to said machine learning chip and stores the non-actional data within said electronic data storage coupled to said machine learning chip, said stored actionable data being stored at a higher resolution than the resolution of the stored non-actionable data.

17. The camera system of claim 11 wherein each said machine learning chip and electronic data storage maintains a first select number of inference rules, and wherein said remote administrator server maintains a second select number of inference rules, wherein said first select number of inference rules is less than said second select number of inference rules.

18. The camera system of claim 11 wherein said remote administrator server includes a machine learning chip.

19. The camera system of claim 11 wherein said remote administrator server includes a global position sensor.

20. The camera system of claim 11 further comprising an ancillary data device in wireless communication with at least one said transceiver of said plurality of camera nodes.

21. The camera system of claim 11 wherein said plurality of camera nodes is a plurality of body mount camera nodes.
